(19) United States
(12) Patent Application Publication
(10) Pub. No.: US 2019/0109828 A1
(43) Pub. Date: Apr. 11, 2019

(54) DATA PROCESSING METHOD, DEVICE AND SYSTEM, AND STORAGE MEDIUM

(71) Applicant: UCloud Technology Co., Ltd., Shanghai (CN)

(72) Inventor: Xiang SONG, Shanghai (CN)

(73) Assignee: UCloud Technology Co., Ltd., Shanghai (CN)

(21) Appl. No.: 15/995,553

(22) Filed: Jun. 1, 2018

(30) Foreign Application Priority Data
Oct. 10, 2017 (CN) 201710936225.1

(51) Int. Cl. H04L 29/06; H04L 9/06; H04L 29/08

(52) U.S. Cl. CPC H04L 63/0428; H04L 67/32; H04L 63/123; H04L 9/0618

(57) ABSTRACT

Data processing method, device and system, and a storage medium are provided. The method includes: performing handshaking operations with a data provider and a data consumer respectively, to send a first key to the data provider and the data consumer respectively; acquiring, from the data provider, first encrypted data, information encrypted by the first key and algorithm call information, wherein the information encrypted by the first key is related to the first encrypted data; processing the first encrypted data based on the information encrypted by the first key and the algorithm call information to obtain second encrypted data; and outputting the second encrypted data to the data consumer.

### CROSS-REFERENCE TO RELATED APPLICATIONS

The present application claims priority to Chinese patent application No. 201710936225.1, filed on Oct. 10, 2017, and entitled “DATA PROCESSING METHOD, DEVICE AND SYSTEM, AND STORAGE MEDIUM”, and the entire disclosure of which is incorporated herein by reference.

### TECHNICAL FIELD

The present disclosure generally relates to data processing, and more particularly, to cloud-based data processing method, device and system, and a storage medium.

### BACKGROUND

In the Internet age, big data transaction has become an important business model. Big data transaction based on a cloud computing platform can make full use of the cloud computing platform's inexpensive and scalable computing and storage capabilities. However, for security reasons, data transaction on cloud is still a challenge. Data providers and data consumers usually worry that a provider of the cloud computing platform may acquire or steal data on the cloud computing platform.

The Chinese patent application with application No. 201611236777.3 and titled “data exchange method and system based on ciphertext” provides a data transaction method based on operable ciphertext technology. Data is encrypted according to requirements by using encryption methods such as completely random encryption, deterministic encryption, sequential deterministic encryption or homomorphic encryption. In this way, the data is transacted on a cloud computing platform based on ciphertext transaction, and ciphertext data can be used to perform operations such as data comparison, data sorting or data calculation to ensure normal operation of the data transaction.

The Chinese patent application with application No. 201380020702X and titled method and system for secure multiparty cloud computation provides a system for secure multiparty cloud computation. The system requires multiple clients to generate encrypted datasets which are encrypted from corresponding plaintext data using particular encryption keys. Then the system re-encrypts the multiple encrypted datasets to a target format, evaluates a function based on the re-encrypted multiple datasets to produce an evaluation outcome, and sends the evaluation outcome to the multiple clients. In the solution, a trusted third party is responsible for production and distribution of re-encryption key pairs.

The Chinese patent application with application No. 201410634598X provides a secure use method of privacy data in cloud computation. Through detection of an exposed chain and key privacy data and recombination with the exposed chain and the key privacy data, continuous privacy data is converted into discrete privacy data, so that personal privacy information of users is protected.

Homomorphic encryption is a cryptographic technique based on computational complexity theory of mathematical problems. Homomorphically encrypted data is processed to obtain an output, and the output is decrypted to obtain a result, where the result is the same as that obtained by processing unencrypted original data in a same way.

The solution in the Chinese patent application with application No. 201380020702X relies on homomorphic encryption, and the solution in the Chinese patent application with application No. 201611236777.3 relies on a relatively weak encryption method (compared with completely random encryption) such as homomorphic encryption, deterministic encryption or sequential deterministic encryption. Therefore, ciphertexts in these solutions have weaker security than that in completely random encryption, and is prone to be decrypted. The solution in the Chinese patent application with application No. 201410634598X does not involve guaranteeing security of data on a third-party cloud server.

Therefore, in existing techniques, security of data transaction and security of data on a third-party cloud server cannot be guaranteed.

### SUMMARY

In an embodiment, a data processing method is provided, including: performing handshaking operations with a data provider and a data consumer respectively, to send a first key to the data provider and the data consumer respectively; acquiring, from the data provider, first encrypted data, information encrypted by the first key and algorithm call information, wherein the information encrypted by the first key is related to the first encrypted data; processing the first encrypted data based on the information encrypted by the first key and the algorithm call information to obtain second encrypted data; and outputting the second encrypted data to the data consumer.

Optionally, the information encrypted by the first key includes a first data processing algorithm and a second key, wherein the data provider encrypts first data with the second key to obtain the first encrypted data.

Optionally, processing the first encrypted data based on the information encrypted by the first key and the algorithm call information to obtain second encrypted data may include: decrypting the first encrypted data with the second key to obtain the first data; invoking an algorithm from the first data processing algorithm based on the algorithm call information; calculating based on the first data using the algorithm to obtain second data; and encrypting the second data with the second key to obtain the second encrypted data.

Optionally, outputting the second encrypted data to the data consumer may include: based on a request from the data consumer, transmitting a second data processing algorithm encrypted with the first key to the data consumer for verification by the data consumer; and transmitting the second encrypted data to the data consumer if the verification is passed.

Optionally, the data provider transmits the first data processing algorithm and the second key to the data consumer in advance, the data consumer verifies whether the first data processing algorithm received from the data provider is the same as the second data processing algorithm encrypted with the first key, and if yes, the verification is passed.

Optionally, the data consumer decrypts the second encrypted data with the second key to obtain the second data.

In an embodiment, a data processing device is provided, including: a handshaking circuitry configured to perform handshaking operations with a data provider and a data consumer respectively, to send a first key to the data provider and the data consumer respectively; an acquiring circuitry configured to acquire, from the data provider, first encrypted data, information encrypted by the first key and algorithm call information, wherein the information encrypted by the first key is related to the first encrypted data; a processing circuitry configured to process the first encrypted data based on the information encrypted by the first key and the algorithm call information to obtain second encrypted data; and an outputting circuitry configured to output the second encrypted data to the data consumer.

In an embodiment, a data processing system is provided, including: a data provider, a data consumer, and the above-mentioned data processing device, wherein the data processing device receives first ciphertext data from the data provider, obtains second ciphertext data after processing the data processing device, and transmits the second ciphertext data to the data consumer.

In an embodiment, a nonvolatile storage medium having data processing programs stored therein is provided, wherein the data processing programs are executed by a computer to implement a data processing method, and include: handshaking programs for performing handshaking operations with a data provider and a data consumer respectively, to send a first key to the data provider and the data consumer respectively; acquiring programs for acquiring, from the data provider, first encrypted data, information encrypted by the first key and algorithm call information, wherein the information encrypted by the first key is related to the first encrypted data; processing programs for processing the first encrypted data based on the information encrypted by the first key and the algorithm call information to obtain second encrypted data; and outputting programs for outputting the second encrypted data to the data consumer.

By embodiments of the present disclosure, data may be processed (transacted) safely via a third-party cloud server.

### BRIEF DESCRIPTION OF THE DRAWINGS

FIG. 1 schematically illustrates a block diagram of a data processing system according to an embodiment;

FIG. 2 schematically illustrates a block diagram of a data processing device according to an embodiment;

FIG. 3 schematically illustrates a flow chart of a data processing method according to an embodiment;

FIG. 4 schematically illustrates a block diagram of a processing circuitry 203 according to an embodiment;

FIG. 5 schematically illustrates a flow chart of a processing step according to an embodiment;

FIG. 6 schematically illustrates a block diagram of an outputting circuitry according to an embodiment; and

FIG. 7 schematically illustrates a flow chart of an outputting step according to an embodiment.

### DETAILED DESCRIPTION

Embodiments of the present disclosure are described in detail below in conjunction with accompanying drawings.

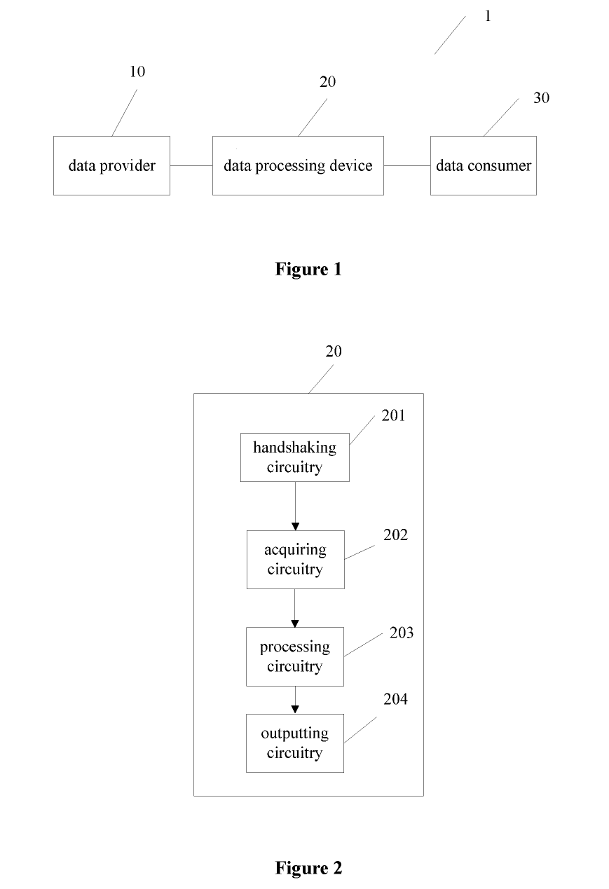

FIG. 1 schematically illustrates a block diagram of a data processing system 1 according to an embodiment. The data processing system 1 includes a data provider 10, a data processing device 20 and a data consumer 30.

FIG. 2 schematically illustrates a block diagram of the data processing device 20 according to an embodiment. The data processing device 20 includes a handshaking circuitry 201, an acquiring circuitry 202, a processing circuitry 203 and an outputting circuitry 204.

In some embodiments, an Intel SGX device on a cloud server (not shown in Figures) may serve as the data processing device 20. The Intel SGX device 20 (referred to as SGX device 20 hereinafter) is a trusted computing device introduced by Intel and its functions are integrated on a CPU. All programs and data running in the SGX device 20 are invisible to an operating system, so that the data provider 10 and the data consumer 30 can still use the SGX device 20 to process data even if the operating system (including a controller of the operating system) is not trusted.

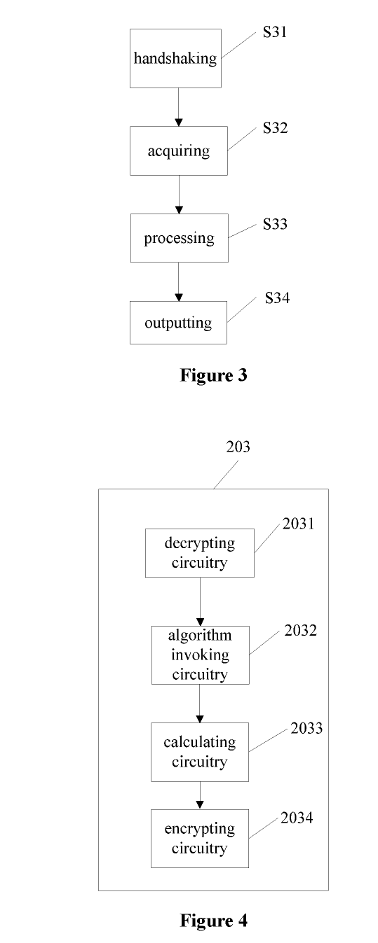

FIG. 3 schematically illustrates a flow chart of a data processing method according to an embodiment.

Referring to FIGS. 2 and 3, in S31, the handshaking circuitry 201 is configured to perform handshaking operations with the data provider 10 and the data consumer 30 respectively, to send a first key to the data provider 10 and the data consumer 30 respectively. The first key is for the data provider 10 and the data consumer 30 to authenticate the SGX device 20. Through S31, the data provider 10 and the data consumer 30 can authenticate the SGX device 20 as a trusted device.

In S32, the acquiring circuitry 202 is configured to acquire, from the data provider 10, first encrypted data, information encrypted by the first key and algorithm call information, wherein the information encrypted by the first key is related to the first encrypted data. The information encrypted by the first key includes a first data processing algorithm and a second key, and the data provider 10 encrypts first data with the second key to obtain the first encrypted data.

The data provider 10 encrypts the information using the first key received from the handshaking circuitry 201, and transmits the information encrypted by the first key to the acquiring circuitry 202. The acquiring circuitry 202 uses the first key to decrypt the information encrypted by the first key, so as to acquire the first data processing algorithm and the second key in the information.

Besides, the data provider 10 encrypts first data to be processed with the second key to acquire the first encrypted data, and transmits the first encrypted data to the acquiring circuitry 202.

Afterward, in S33, the processing circuitry 203 is configured to process the first encrypted data based on the information encrypted by the first key and the algorithm call information to obtain second encrypted data.

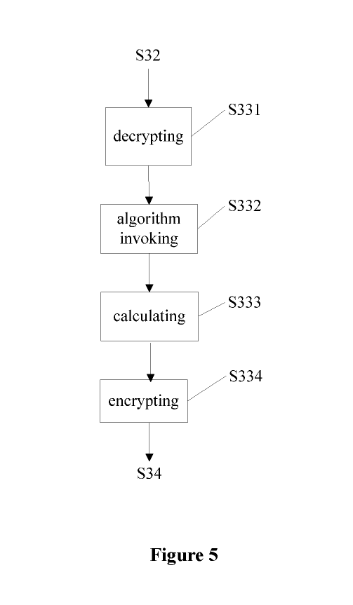

FIG. 4 schematically illustrates a block diagram of the processing circuitry 203 according to an embodiment. The processing circuitry 203 includes a decrypting circuitry 2031, an algorithm invoking circuitry 2032, a calculating circuitry 2033 and an encrypting circuitry 2034. FIG. 5 schematically illustrates a flow chart of S33 according to an embodiment.

Referring to FIGS. 4 and 5, in S331, the decrypting circuitry 2031 is configured to decrypt the first encrypted data with the second key to obtain the first data. In S332, the algorithm invoking circuitry 2032 is configured to invoke an algorithm from the first data processing algorithm based on the algorithm call information acquired by the acquiring circuitry 202. In S333, the calculating circuitry 2033 is configured to calculate based on the first data using the algorithm to obtain second data which is to be transmitted to the data consumer 30.

In the calculating circuitry 2033 of the SGX device 20, a calculation operation is performed to the first data of a plaintext, and thus operation to any type of first data can be supported without any restriction. Therefore, any type of data may be processed in embodiments of the present disclosure.

In S334, the encrypting circuitry 2034 is configured to encrypt the second data with the second key to obtain the second encrypted data.

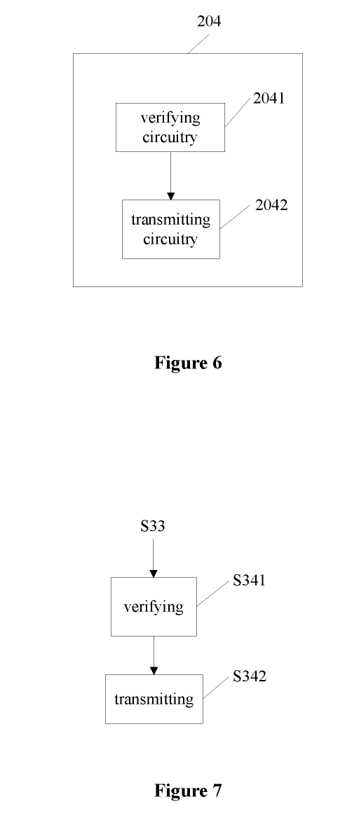

FIG. 6 schematically illustrates a block diagram of the outputting circuitry 204 according to an embodiment, where the outputting circuitry 204 includes a verifying circuitry 2041 and a transmitting circuitry 2042. FIG. 7 schematically illustrates a flow chart of S34 according to an embodiment.

Referring to FIG. 7, in S341, the verifying circuitry 2041 is configured to: based on a request from the data consumer 30, transmit a second data processing algorithm encrypted with the first key to the data consumer 30 for verification by the data consumer 30.

In some embodiments, the data provider 10 may negotiate with the data consumer 30 in advance, and transmit the first data processing algorithm and the second key to the data consumer 30 in advance. The data consumer 30 verifies whether the first data processing algorithm received from the data provider 10 is the same as the second data processing algorithm encrypted with the first key which is received from the verifying circuitry 2041. If yes, the verification is passed. That is, if the verification is passed, it is indicated that the second encrypted data is the data to be provided to the data consumer 30.

By the verification in S341, it is further determined whether the second encrypted data is the data to be provided to the data consumer 30 and not data illegally tampered by a third party.

Afterward, in S342, the transmitting circuitry 2042 is configured to transmit the second encrypted data to the data consumer 30 if the verification is passed.

After receiving the second encrypted data, the data consumer 30 decrypts the second encrypted data with the second key received from the data provider 10 to obtain the second data.

In embodiments of the present disclosure, the second key used for data encryption is stored by the data provider, the data consumer and the SGX device. Even the cloud server cannot obtain the second key, thus, data security can be ensured. Further, the data processing is performed in the SGX device. As the SGX device provides trusted computing support, internal data of the SGX device cannot be obtained by others including an operating system kernel. Therefore, any constituent members (such as system administrator, operation and maintenance staff, or research and development staff) in the cloud server cannot obtain the processed data. Therefore, an inexpensive cloud server may be used to perform secure data processing (data transaction), that is, a high-security and low-cost data processing method may be provided.

Further, the second key may be encrypted by directly using a conventional encryption method (such as AES), and this type of encryption method is more secure than methods such as homomorphic encryption, deterministic encryption or sequential deterministic encryption.

Further, in the SGX device 20, a calculation operation is performed to the first data of a plaintext, and thus operation to any type of first data can be supported without any restriction. Therefore, any type of data may be processed in embodiments of the present disclosure.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A data processing method, comprising:
performing handshaking operations with a data provider and a data consumer respectively, to send a first key to the data provider and the data consumer respectively;
acquiring, from the data provider, first encrypted data, information encrypted by the first key and algorithm call information, wherein the information encrypted by the first key is related to the first encrypted data;
processing the first encrypted data based on the information encrypted by the first key and the algorithm call information to obtain second encrypted data; and
outputting the second encrypted data to the data consumer.

2. The method according to claim 1, wherein the information encrypted by the first key comprises a first data processing algorithm and a second key, wherein the data provider encrypts first data with the second key to obtain the first encrypted data.

3. The method according to claim 2, wherein processing the first encrypted data based on the information encrypted by the first key and the algorithm call information to obtain second encrypted data comprises:
decrypting the first encrypted data with the second key to obtain the first data;
invoking an algorithm from the first data processing algorithm based on the algorithm call information;
calculating based on the first data using the algorithm to obtain second data; and
encrypting the second data with the second key to obtain the second encrypted data.

4. The method according to claim 3, wherein outputting the second encrypted data to the data consumer comprises:
based on a request from the data consumer, transmitting a second data processing algorithm encrypted with the first key to the data consumer for verification by the data consumer; and
transmitting the second encrypted data to the data consumer if the verification is passed.

5. The method according to claim 4, wherein the data provider transmits the first data processing algorithm and the second key to the data consumer in advance, the data consumer verifies whether the first data processing algorithm received from the data provider is the same as the second data processing algorithm encrypted with the first key, and if yes, the verification is passed.

6. The method according to claim 5, wherein the data consumer decrypts the second encrypted data with the second key to obtain the second data.

7. A data processing device, comprising:
a handshaking circuitry configured to perform handshaking operations with a data provider and a data consumer respectively, to send a first key to the data provider and the data consumer respectively;
an acquiring circuitry configured to acquire, from the data provider, first encrypted data, information encrypted by the first key and algorithm call information, wherein the information encrypted by the first key is related to the first encrypted data;
a processing circuitry configured to process the first encrypted data based on the information encrypted by the first key and the algorithm call information to obtain second encrypted data; and
an outputting circuitry configured to output the second encrypted data to the data consumer.

8. The device according to claim 7, wherein the information encrypted by the first key comprises a first data processing algorithm and a second key, wherein the data provider encrypts first data with the second key to obtain the first encrypted data.

9. The device according to claim 8, wherein the processing circuitry further comprises:
a decrypting circuitry configured to decrypt the first encrypted data with the second key to obtain the first data;
an algorithm invoking circuitry configured to invoke an algorithm from the first data processing algorithm based on the algorithm call information;
a calculating circuitry configured to calculate based on the first data using the algorithm to obtain second data; and
an encrypting circuitry configured to encrypt the second data with the second key to obtain the second encrypted data.

10. The device according to claim 9, wherein the outputting circuitry further comprises:
a verifying circuitry configured to: based on a request from the data consumer, transmit a second data processing algorithm encrypted with the first key to the data consumer for verification by the data consumer; and
a transmitting circuitry configured to transmit the second encrypted data to the data consumer if the verification is passed.

11. The device according to claim 10, wherein the data provider transmits the first data processing algorithm and the second key to the data consumer in advance, the data consumer verifies whether the first data processing algorithm received from the data provider is the same as the second data processing algorithm encrypted with the first key, and if yes, the verification is passed.

12. The device according to claim 11, wherein the data consumer decrypts the second encrypted data with the second key to obtain the second data.

13. A data processing system, comprising:
a data provider, a data consumer, and a data processing device according to claim 7,
wherein the data processing device receives first ciphertext data from the data provider, obtains second ciphertext data after processing the data processing device, and transmits the second ciphertext data to the data consumer.

14. A nonvolatile storage medium having data processing programs stored therein, wherein the data processing programs are executed by a computer to implement a data processing method, and comprise:
handshaking programs for performing handshaking operations with a data provider and a data consumer respectively, to send a first key to the data provider and the data consumer respectively;
acquiring programs for acquiring, from the data provider, first encrypted data, information encrypted by the first key and algorithm call information, wherein the information encrypted by the first key is related to the first encrypted data;
processing programs for processing the first encrypted data based on the information encrypted by the first key and the algorithm call information to obtain second encrypted data; and
outputting programs for outputting the second encrypted data to the data consumer.
